(19) United States
(12) Patent Application Publication
(10) Pub. No.: US 2023/0059001 A1
(43) Pub. Date: Feb. 23, 2023

(54) METHOD OF TRADING AND SYSTEM OF ITS EMBODIMENT

(71) Applicant: Davit TOPHCHISHVILI, Tbilisi (GE)

(72) Inventor: Davit TOPHCHISHVILI, Tbilisi (GE)

(21) Appl. No.: 17/796,690

(22) PCT Filed: Feb. 12, 2021
(86) PCT No.: PCT/GE2021/050004

§ 371 Date: Aug. 1, 2022

(30) Foreign Application Priority Data
Feb. 14, 2020 (GE) AP 2020 15277

(51) Int. Cl. G07G 1/00; G06Q 30/06; G07C 9/00; G06F 3/044

(52) U.S. Cl. CPC G07G 1/0036; G06F 3/044; G06Q 30/0633; G07C 9/00896

(57) ABSTRACT

The method provides for taking by a customer of a shopping cart and passing the entry checkpoint, taking out of products from shelved cabinets with weight sensors and putting into the shopping cart, monitoring the number of products and calculation of the sum payable.Human body communication system is being used.Customer is identified by means of a pre-coded shopping cart when passing through the checkpoint and touching the sensor element of the checkpoint and the cart handle,following which the customer is let into the shopping area.Customer opens cabinet door,retouches its handle and the cart handle simultaneously, also sensor element and the cart handle while going through the checkout barrier. Customer is informed about charged sum, after paying by a card the customer leaves shopping area. The invention provides also a system for embodiment of the mentioned method.

The invention relates to the retail field and can be used in the facilities equipped with shopping process automation equipment, where the customer’s actions are monitored and the process is computer managed.

Retail facilities,for example super- or hypermarkets, where the shopping processes-customer actions when choosing a product, taking a product from a shelf, placing into the cart, etc. are controlled by a facial recognition system’s video-eye, are widely known today. Additionally, such retail facilities have, as a rule, an entry checkpoint in the form of customer turnstiles and a checkout barrier or other kind of structures,which,simultaneously but not always,are provided with touch elements, such, for example, as buttons constituting a part of a computer control system and letting a customer into the shopping area. The shopping processes in such facilities usually lack complete automation, which is just their shortcoming. Also known are the retail facilities, where shopping is computerized and the process is fully automated. Shopping there is carried out by means of a complex, multicomponent system, where video monitoring with follow-up data processing is one of its main components. At retailing,a customer makes use of mobile apps. An example of such shopping process is Amazon Go [see www.google.com/search?q=amazon+go.... }. Such technology makes it possible to achieve a technical result similar to that of the proposed patentable invention, but requires much capital investment,its implementation system being complicated in terms of its use as well. The employed video monitoring cannot prevent fully product loss due to theft.

According to the proposed object of the invention, the technical result is to eliminate shortcomings characteristic for the known art; in particular, it is aimed at simplifying, cheapening and increasing reliability of the retail management technology systems, eliminating any possibility of product loss due to its concealment/theft.

The present invention proposes a technological possibility of identification of a customer of the retail facility, which makes it possible for a computer to identify the customer and control fully the shopping process according to the unique number(code) assigned to the shopping cart. In addition, the settlement here is cashier-less.

The above-mentioned technical result has become achievable by finding a novel inventive idea, implying the proposal for implementing the shopping processes based on the body communication system technology. For example,such technology is used in promotional activities. A fragmental application of the system is known in automatic teller machines (ATMs) having a touch sensor element, which when activated obtains from the human body necessary information,identifies the person and ensures cashing from the ATM.

The essence of the proposed invention according to claim 1, where a novel shopping method is presented consists in that the retailing technology is based on the human body communication technology principle,where a customer functions as a 1-4 MHz frequency conductivity element;before entry into the shopping area, the customer takes a shopping cart assigned with a unique code(identification number)and in the course of the entire shopping process the customer is identified by this code. Initially, upon entering the shopping area, the customer touches simultaneously the cart handle and the sensor element of the entry checkpoint, following which he/she is let into the shopping area. Likewise, he/she is identified during taking a cart, for which he/she simultaneously touches the cart and the shelf handle; the same procedure takes place at passing the checkout barrier, when the customer retouches simultaneously the cart handle and the checkout sensor element. At that time,the customer is presented with a bill for payment,pays the price of the purchased products with a credit card and leaves the retail area.

According to claim 2 of the invention, describing a system necessary for implementing the method presented in claim 1, the essence of the invention consists in proposing such system arrangements, the use of which will upon implementation of the shopping processes ensure connection of the system components by means of the human body communication technology and system perception and processing of information and issue of respective orders to manage the shopping process.

In compliance with the above and according to claim 2, the shopping process is conducted by means of a cabinet connected to the autonomous systems of the entry checkpoint, comprising the listed therein components and the interconnected wire or wireless LAN(Local Area Network, hereinafter LAN) systems, making use of a server through the similar established connection. In addition,the shopping cart handle with a pre-assigned unique code (identification number) is made of a conductive material and is configured to function as an antenna. Simultaneously, the cart has its autonomous system that generates a digital signal and transfers a unique code, when the customer’s body serves as a conductor between the cart and the entry checkpoint, between the cart and the cabinet, as well as between the cart and the checkout barrier.

Examples of the design and manufacture of individual components of the described systems are given in claims 2-6 of the present invention.

According to the invention, the shopping method is implemented as follows: a customer upon entry in the retail facility shall take a cart, the handle of which is configured to function as a transmission antenna which transfers the unique code of the cart to respective retail systems. When passing the entry checkpoint, the customer will necessarily touch the cart handle and the checkpoint sensor element in the form of a plate, for example, configured to function as an antenna. As a result, the entry checkpoint system perceives and keeps the unique cart code and identifies the customer therewith. Thereafter, the entry checkpoint system orders the customer’s letting into the shopping area.

The customer goes to the interested cabinet and opens its door to choose a product. At that time, the customer will necessarily touch the cabinet and cart handles. Here too the cart handle is configured to function as a transmission antenna,while that of the cabinet as a reception one; the customer’s body functions as a 1-4 MHz frequency conductor. The cart and the cabinet become interconnected; the cabinet system identifies the customer by perceiving the unique cart code, remembers it and orders the opening of the electronically locked cabinet. Upon taking out of desired products, the system identifies the selected product and its weight using a weight sensor, remembers the data and communicates them to the server, which, by means of LAN serves this and the checkout barrier system.

After the product has been chosen,the customer goes to the checkout barrier, touches simultaneously the cart handle and the checkout barrier sensor element that is configured to function as a reception antenna;the cart and the cabinet become re-connected;the customer is identified in a manner described above. Simultaneously, the customer can see the bill on a monitor. Once the bill has been paid by a credit card, the interconnected LAN will issue a respective order and the customer will leave the checkout and the retail facility area.

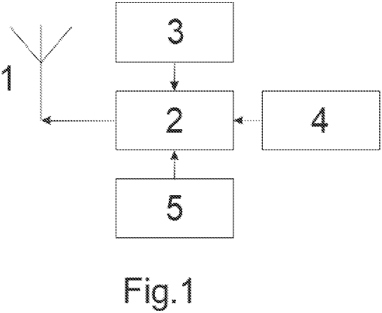

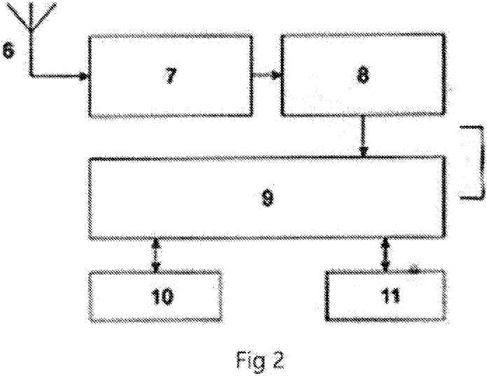

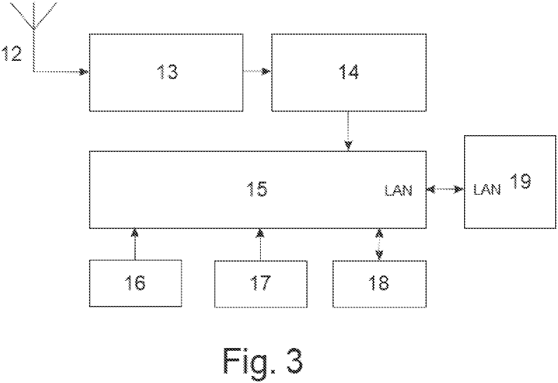

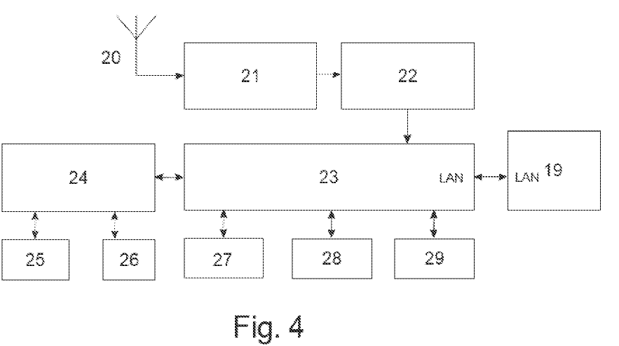

To implement the described method,the systems represented by the diagrams given below are provided for:
FIG. 1- The cart autonomous system;
FIG. 2-The entry checkpoint autonomous system;
FIG. 3-The cabinet system;
FIG. 4- The checkout barrier system.

FIG. 1 is a schematic illustration of the cart’s autonomous system proper. The cart itself (not depicted) represents an ordinary shopping cart that can be hand carry and rolling.Most important, in order to function as a transmission antenna and the human body communication means it should be made of conductive material. In fact, its handle can be considered as an antenna. It is indicated in the diagram as position 1. At that, according to one of the embodiments, the cart handle is configured as a hollow element with a built in piece of ordinary wire and the cart electronic system, which beside the antenna 1 connected to an amplitude- modulated transmitter 2, is also connected to the coder 3 that emits a digital signal of the unique cart code,power source 4, and 1-4 MHz frequency electrical generator 5. The cart electronic system of a different design can be arranged, for example,as a printed circuit board, directly on the cart, in any convenient place. In order to make it more attractive for the customer,the cart handle is covered with a non-metal thin film, or is painted.

The entry checkpoint system is illustrated in FIG. 2 and represents,for example,customer turnstiles (not depicted in FIG. 2)with a built-in conductive sensor element-antenna 6, which can be a steel plate functioning as a reception antenna. The touching of this element enables identification of the unique cart code and of a customer,when the person simultaneously touches the cart handle; antenna 6 is connected to an amplitude-modulator receiver - demodulator 7, which is connected to a digital decoder 8 that converts the analog signal containing the unique cart code to the digital one;in return, decoder 8 is linked to a microcontroller 9, which gives an order for letting a customer into the retail area, photo sensor 10, and the door locking-unlocking mechanism 11 that operates based on an order received from microcontroller 9 and locks or unlocks the door of the entry checkpoint-the customer turnstiles for example.

FIG. 3 illustrates a cabinet system. The cabinet has a shelf for storing products(the cabinet itself and the shelf are not depicted in the figure)and,for example, the cabinet handle made of a conductive material and configured to function as an antenna-antenna 12, which, according to one embodiment, is hollow and wherein a piece of an ordinary wire and a cabinet system are built in.In other case,the system is arranged as a printed circuit board in any convenient place of the cabinet. In addition to antenna 12, the cabinet system comprises an AM receiver 13 connected thereto and to decoder 14, which is also connected to a microcontroller 15 and the door sensor 16 that controls the cabinet door unlocking and transfers the relevant information to the microcontroller 15, which occurs only in the case when a customer is identified, for which purpose the person is necessarily and simultaneously to touch the cart handle 1(FIG. 1) and the door handle 12. The electromagnetic lock 17 is also connected to the microcontroller 15, The system includes also electronic scales 18 of the product shelf also connected to the microcontroller 15. After the cabinet door has been locked,the microcontroller activates the information received from the electronic scales and transfers it to the server 19, which is connected to said microcontroller 15 through LAN and serves simultaneously the cabinet system described in FIG. 3 and the checkout barrier system(FIG. 4).

The checkout barrier system illustrated in FIG. 4 comprises a touch element made of conductive material, completed,for example,as a plate and arranged on the customer turnstiles of the entry checkpoint. This element is configured to function simultaneously as an antenna and is depicted in the diagram as antenna 20. Here too the customer touches simultaneously the element 20 and the cart handle 1(FIG. 1), as a result of which the person is identified. In addition,said system comprises the AM receiver 21 connected to the antenna 20 and the decoder 22 connected thereto. The decoder, which, in turn, is connected to the computer 23, activates the information received from the server and after the bill has been paid,orders for letting out the customer. In addition to the microcontroller 24, the photo sensor 25 and the check-out barrier door locking/unlocking mechanism, the computer is also connected to a monitor 27, which displays the price of the purchased products calculated based on the information received, the printer 28 and the credit card payment terminal 29. As has been mentioned, the cabinet system (FIG. 3) and the checkout barrier system are served by one server 19, connected thereto by means of LAN.

It should also be mentioned that existence of the credit card payment terminal does not exclude a possibility of payment by cash and of implementation of the present invention, which can be practical by the methods known to experts. Therefore, due to the above and based on the invention purposes,description of such an option has not been considered reasonable.

Components of the described systems fulfilown standardized functions and serve the following task: identification of a customer, letting into the shopping area, tracking and monitoring of the selected product, calculation of the payable amount,its presentation to the customer, and letting out of the customer in case the amount has been paid. If the amount has not been paid in full or in part, the order on the customer’s letting out will not be given.

It is obvious for an expert that any system in the described retail management technology can have individual interconnected servers, for example through the same LAN. Also obvious is that the described technology systems can be arranged as modules of a unified system and be so managed. This aspect, however, is not emphasized,because an optimal embodiment of the invention has been described. By the implementation and use of the so presented invention the set objective under the technical result indicated above can be achieved. In terms of economy, implementation of the invention requires a minimum capital investment as compared with implementation of the Amazon Go technology. The retail management technology of the present invention based on a constant cart-customer communication in addition to being cashier-less, almost prevents product loss due to theft, which cannot be achieved by means of video monitoring. The selected product cannot be concealed, because under the technology proposed by this invention the product weight and quantity will be pre-determined and correspondingly displayed on the checkout barrier monitor 27.

1. A method of trading under conditions of computer system management providing for taking by a customer of a shopping cart, passing through the entry checkpoint and the checkout area, taking of a products from a cabinet with shelves with electronic scales and placing into the cart, recording the product amount and calculation of the amount payable differs by using the human body communication technology, for which the customer fulfills the function of a 1-4 MHz frequency conducting element, is identified by the pre- coded shopping cart when walking through the entry checkpoint, for which the person simultaneously touches a touch sensor element of the checkpoint and the handle of the cart taken before walking through the checkpoint, after which the person is let into the shopping area, by opening the cabinet door the customer touches simultaneously the cabinet door and the cart handle, when walking through the checkout barrier the customer re- touches simultaneously the checkpoint’ s touch element and the cart handle, as a result of which the person is informed about the payable sum amount, after the payment of which the customer leaves the shopping area.

2. The system of claim 1 wherein it comprises a shopping cart and its system,the entry checkpoint system, the cabinet system and the checkpoint barrier system, and wherein the cabinet system comprises a handle functioning as an antenna,power source,a 1-4 MHz frequency electric generator,an amplitude-modulator(AM)transmitter and a coder, whereon the unique cart code is recorded and stored,the entry checkpoint with own autonomous system,comprising the touch element of this checkpoint arranged,for example, on the customer turnstiles, configured to function as a reception antenna,an amplitude-modulated(AM)receiver connected to a decoder,which,in turn,is connected to a microcontroller,to which also connected are the photo sensor and the cabinet door locking/ unlocking mechanism, and wherein the cabinet system with shelves with a weight sensor and a handle of the door configured to function as an antenna comprises an AM receiver connected to the decoder which, in turn, is connected to a microcontroller,to which also connected are the door sensor and the electronic lock, as well as electronic scales of the cabinet shelf; and wherein the checkout area system comprises a touch element configured to function as an antenna, an AM receiver connected to a decoder,which is connected to a computer which is also connected to a monitor, printer credit card payment terminal and microcontroller,to which connected are the checkout area sensor and the locking/unlocking mechanism thereof,and wherein the cabinet and the checkpoint area systems are connected to the general server by means of LAN.

3. The system of claim 2 wherein the shopping cart handle is hollow and contains a built-in element made of a conductive material and configured to function as an antenna.

4. The system of claim 2 wherein the cabinet door is arranged with a touch element made of a conductive material in the form of a plate, for example, and configured to function as an antenna.

5. The system of claim 2 wherein the cabinet door handle is hollow and contains an element made of a conductive material configured to function as an antenna.
